(19) United States
(12) Patent Application Publication
(10) Pub. No.: US 2025/0326139 A1
(43) Pub. Date: Oct. 23, 2025

(54) Knife with Blade Storage

(71) Applicant: Milwaukee Electric Tool Corporation, Brookfield, WI (US)

(72) Inventors: Niqi Zhang, Huarong City (CN); Andrew M. Tuchscherer, Wauwatosa, WI (US); Scott M. Hangartner, Richfield, WI (US)

(21) Appl. No.: 19/252,554

(22) Filed: Jun. 27, 2025

Related U.S. Application Data
(63) Continuation of application No. 17/222,587, filed on Apr. 5, 2021, now Pat. No. 12,365,104.
Application No. 17/222,587 is a continuation of application No. PCT/CN2021/078368, filed on Mar. 1, 2021.
(60) Provisional application No. 62/986,134, filed on Mar. 6, 2020.

(51) Int. Cl. B26B 5/00; B25G 1/08; B26B 11/00

(52) U.S. Cl. CPC B26B 5/00; B25G 1/08; B26B 11/00

(57) ABSTRACT

A knife with a replacement blade stored within the knife is provided. The knife allows the replacement blade to be easily and quickly accessible. An arm is movable between a locked and unlocked position. In the locked position the arm interfaces with the replacement blade to restrain the replacement blade from being removed.

### CROSS-REFERENCE TO RELATED PATENT APPLICATIONS

The present application is a continuation of U.S. application Ser. No. 17/222,587, filed on Apr. 5, 2021, which is a continuation of International Application No. PCT/CN2021/078368 filed on Mar. 1, 2021, which claims the benefit of and priority to U.S. Provisional Application No. 62/986,134, filed on Mar. 6, 2020, which are incorporated herein by reference in their entireties.

### BACKGROUND OF THE INVENTION

The present invention relates generally to the field of knives. The present invention relates specifically to a knife, such as a folding knife, that includes a storage location for one or more replacement blades.

### SUMMARY OF THE INVENTION

One embodiment of the invention relates to knife, such as a utility knife, including a handle, a liner coupled to the handle, a first blade with a cutting edge, a blade holder coupled to the first blade and pivotal with respect to the handle, and a second blade. The handle includes a pair of handle members opposite each other, with a handle cavity defined between the pair of handle members. The blade holder is pivotal with respect to the handle between an extended position where the cutting edge of the first blade is exposed and configured to cut a work-piece and a folded position where the cutting edge of the first blade is within the handle cavity. The liner is between the pair of handle members (e.g., within the handle cavity) and includes a spring arm that is movable between a locked position and an unlocked position. The second blade interfaces with the spring arm of the liner, such as via a notch defined by the second blade. The interface between the spring arm and the second blade restrains the second blade from being removed from the handle cavity when the spring arm is in the locked position. When the spring arm is moved into the unlocked position the spring arm no longer interfaces with the second blade and the second blade is removable from the handle cavity.

In a specific embodiment the liner comprises a body that defines a plane, and the spring arm extends laterally from the liner body such that the spring arm is not coplanar with the liner body when the spring arm is in the locked position. When the spring arm is moved from the locked position towards the unlocked position the spring arm is moved in a direction towards being coplanar with the liner body. In a specific embodiment the spring arm defines a U-shaped projection and the notch defines a U-shaped cutout, and the U-shaped projection interfaces against the U-shaped cutout when the spring arm is in the locked position.

Another embodiment of the invention relates to a utility knife including a handle having an interior surface defining a handle cavity and a liner coupled to the handle. The liner is disposed at least partially within the handle cavity. The liner includes a spring arm movable between a locked position and an unlocked position. The utility knife includes a first blade including a cutting edge. The utility knife includes a blade holder coupled to the first blade. The blade holder is pivotable with respect to the handle between an extended position where the cutting edge of the first blade is exposed and configured to cut a work-piece and a folded position where the cutting edge of the first blade is within the handle cavity. The utility knife includes a second blade that interfaces with the spring arm. The interface between the spring arm and the second blade restrains the second blade from being removed from the handle cavity when the spring arm is in the locked position. The second blade is removable from the handle cavity when the spring arm is in the unlocked position.

Another embodiment of the invention relates to a utility knife including a handle having an interior surface defining a handle cavity and a liner coupled to the handle. The liner is disposed at least partially within the handle cavity. The utility knife includes a first blade including a cutting edge. The utility knife includes a blade holder coupled to the first blade. The blade holder is pivotable with respect to the handle between an extended position where the cutting edge of the first blade is exposed and configured to cut a work-piece and a folded position where the cutting edge of the first blade is within the handle cavity. The utility knife includes a second blade including a first notch that interfaces with the liner. The interface between the liner and the first notch restrains the second blade from being removed from the handle cavity.

Another embodiment of the invention relates to a utility knife including a handle having an interior surface defining a handle cavity and a liner coupled to the handle. The liner is disposed at least partially within the handle cavity. The liner includes a body and a biasing element that extends laterally from the body. The biasing element is movable between a locked position and an unlocked position. The utility knife includes a first blade including a cutting edge. The utility knife includes a blade holder coupled to the first blade. The blade holder is pivotable with respect to the handle between an extended position where the cutting edge of the first blade is exposed and configured to cut a work-piece and a folded position where the cutting edge of the first blade is within the handle cavity. The utility knife includes a second blade that interfaces with the biasing element. The interface between the biasing element and the second blade restrains the second blade from being removed from the handle cavity when the biasing element is in the locked position. The second blade is removable from the handle cavity when the biasing element is in the unlocked position.

Additional features and advantages will be set forth in the detailed description which follows, and, in part, will be readily apparent to those skilled in the art from the description or recognized by practicing the embodiments as described in the written description and claims hereof, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

FIG. 1 is a perspective view of a knife, according to an embodiment.

FIG. 2 is another perspective view of the knife of FIG. 1.

FIG. 3 is a perspective view of several components of the knife of FIG. 1.

FIG. 4 is a perspective view of several components of the knife of FIG. 1.

FIG. 5 is a top view of a liner of the knife of FIG. 1.

FIG. 6 is a detailed top view of the liner of FIG. 5.

FIG. 7 is a perspective view of a liner and blade holder of the knife of FIG. 1.

### DETAILED DESCRIPTION

Referring generally to the figures, various views of a knife, shown as a foldable knife, are depicted. In one embodiment, the knife includes a blade holder coupled to a blade. The knife also includes a liner that restrains a replacement blade, such as in a storage cavity within the handle. When the active or used blade (e.g., the blade coupled to the blade holder) gets too worn or breaks, the user can quickly obtain a replacement blade within the knife itself and replace the worn or broken blade with the replacement blade by attaching the replacement blade to the blade holder. The liner securely restrains the replacement blade within the storage cavity of the knife while the knife is in use. An interface for actuating the liner permits a user to easily remove the replacement blade for use when needed.

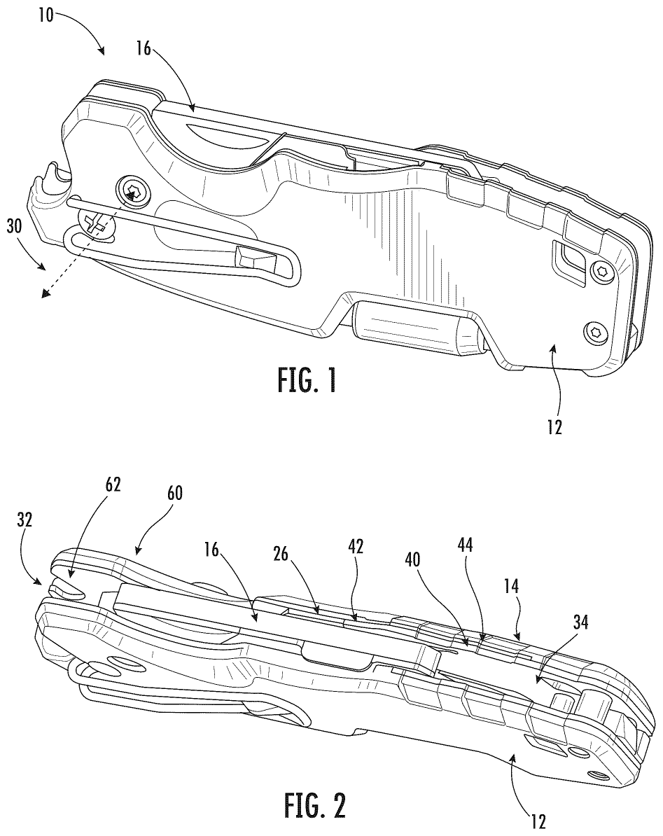

Referring to FIGS. 1-2, a cutting device, folding knife and/or utility knife, such as knife 10, is shown according to an exemplary embodiment. Knife 10 includes handle 60 having an interior surface 62 defining handle cavity 32. In a specific embodiment, handle 60 includes opposing first and second handle members, shown as first elongate side handle member 12 and second elongate side handle member 14. In a specific embodiment first elongate side handle member 12 and second elongate side handle member 14 are coupled together. Blade holder 16 is pivotally coupled to first and second handle members 12, 14 and rotates about axis 30 with respect to first and second handle members 12, 14. First handle member 12 and second handle member 14 collectively define handle cavity 32. Blade holder 16 pivots into and out of handle cavity 32 via slot 34 on the top of first and second handle members 12, 14.

Liner 40 is coupled to first and second handle members 12, 14 and is disposed at least partially disposed within handle cavity 32 between first and second handle members 12, 14. Liner 40 includes a biasing element, shown as spring arm 42, which extends laterally from body 44 of liner 40.

Spring arm 42 is movable between a locked position and an unlocked position. In the locked position, spring arm 42 interfaces with a second blade, shown as stored blade 26. In a specific embodiment, liner 40 interfaces with notch 28 of stored blade 26 and more particularly spring arm 42 interfaces with stored blade 26. The interface between spring arm 42 and stored blade 26 restrains stored blade 26 from being removed from handle cavity 32 when spring arm is in the locked position, and stored blade 26 is removable from handle cavity 32 when spring arm 42 is in the unlocked position. In a specific embodiment, stored blade 26 includes notch 28, and spring arm 42 interfaces with notch 28 of stored blade 26. In a specific embodiment, stored blade 26 is disposed between second handle member 14 and liner 40.

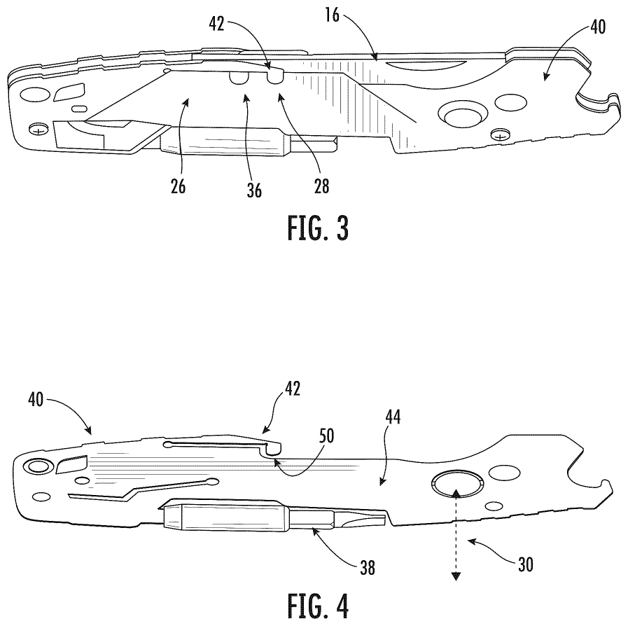

Turning to FIGS. 3-6, stored blade 26 defines notch 28 and notch 36, shown as cutouts. Spring arm 42 interfaces against notch 28 to restrain stored blade 26 within handle cavity 32 when spring arm 42 is in the locked position, such as by end surface 50 of spring arm 42 interfacing against notch 28. A supplemental hand tool, shown as flathead screwdriver 38, is detachably coupled to knife 10. Flathead screwdriver 38 is configured to decouple active blade 18 from blade holder 16 and subsequently couple stored blade 26 to blade holder 16 after stored blade 26 has been removed from handle cavity 32.

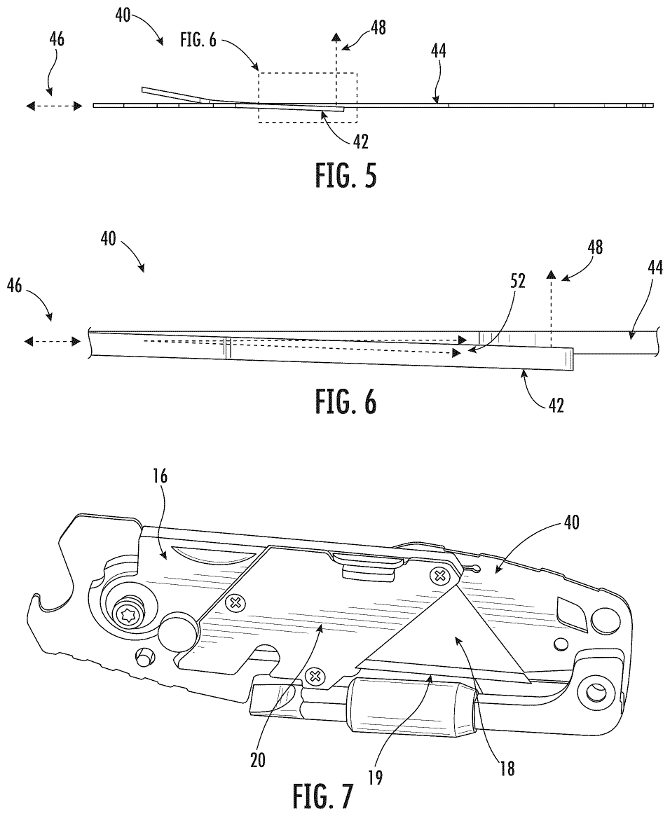

Turning to FIGS. 5-6 in particular, liner 40 includes body 44 that defines plane 46. Spring arm 42 extends laterally from body 44 such that spring arm 42 is not coplanar with plane 46. As shown in FIGS. 5-6, spring arm 42 defines an angle 52 with respect to plane 46. When spring arm 42 is in the locked position, spring arm 42 defines a non-zero angle 52 with respect to plane 46. When spring arm 42 is actuated and/or transitioned from the locked position to the unlocked position, spring arm 42 is moved in direction 48, and angle 52 between spring arm 42 and plane 46 is decreased. In a specific embodiment, spring arm 42 moves away from second handle member 14 when spring arm 42 moves in direction 48 and transitions from the locked position to the unlocked position.

Turning to FIG. 7, depicted therein is blade holder 16 coupled to a first blade, shown as active blade 18, via plate 20. Blade holder 16 is pivotally coupled to first and second handle members 12, 14. Blade holder 16 is rigidly coupled to active blade 18, such as via fasteners that secure plate 20 to blade holder 16, thereby securing active blade 18. Active blade 18 includes cutting edge 19. Blade holder 16 is pivotable with respect to handle 60 between an extended position where the cutting edge 19 of the active blade 18 is exposed and configured to cut a work-piece and a folded position where the cutting edge 19 of the active blade 18 is within the handle cavity 32.

In use, blade holder 16 is pivotal with respect to the first and second handle members 12, 14 between an extended position where cutting edge 19 of active blade 18 is exposed and configured to cut a work-piece, and a folded position where cutting edge 19 of active blade 18 is not exposed (e.g., within handle cavity 32). Blade holder 16 pivots from the extended position to the folded position via pivoting through slot 34 on top side of first and second elongate side handle members 12, 14 and into handle cavity 32.

In a specific embodiment, notches 28, 36 each define a U-shaped cutout. In a specific embodiment, notches 28, 36 are recesses rather than cutouts.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the invention relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

What is claimed is:

1. A utility knife comprising:
a handle comprising:
a top;
a bottom;
an interior surface defining a cavity; and
a slot on the top of the handle connected to the cavity;
a liner coupled to the handle and positioned within the cavity, the liner comprising:
a body;
an arm extending from the body, the arm comprising:
a first end connected to the body;
a second end opposing the first end, the second end comprising a projection;
a first blade comprising a cutting edge;
a blade holder coupled to the first blade, the blade holder pivotable with respect to the handle; and
a second blade positioned between the liner and the handle, the second blade comprising a notch, wherein the projection engages the notch in a locked position.

2. The utility knife of claim 1, wherein the projection comprises an end surface configured to engage the notch.

3. The utility knife of claim 2, wherein the end surface is curved.

4. The utility knife of claim 1, wherein the second blade is positioned between a first side of the handle and the liner, and wherein the blade holder is positioned between a second side of the handle and the liner.

5. The utility knife of claim 1, wherein the body defines a plane, and wherein the arm extends from the body at an angle with respect to the plane when the arm is in the locked position.

6. The utility knife of claim 5, wherein, when the arm moves into an unlocked position the arm moves laterally within the cavity toward the body.

7. The utility knife of claim 6, wherein the angle between the arm and the body decreases when the arm is transitioned from the locked position toward the unlocked position.

8. The utility knife of claim 1, wherein the blade holder is moveable between a folded position in which the first blade is positioned within the cavity and an extended position in which the cutting edge is exposed.

9. A utility knife comprising:
a handle comprising:
a first elongate side;
a second elongate side opposing the first elongate side;
a top;
a bottom opposing the top; and
an interior surface defining a cavity, the cavity connected to a slot defined in the top of the handle;
a liner coupled to the handle, the liner positioned within the cavity, the liner comprising:
a body extending along the second elongate side; and
an arm comprising:
a first end connected to the body;
a second end; and
a projection coupled to the second end, the projection comprising a curved end surface;
a first blade comprising a cutting edge;
a blade holder coupled to the first blade, the blade holder pivotable through the slot of the handle; and
a second blade comprising a notch that interfaces with the projection of the arm of the liner.

10. The utility knife of claim 9, wherein the interface between the projection of the liner and the notch restrains the second blade from being removed from the cavity when the liner is in a locked position.

11. The utility knife of claim 10, wherein the second blade is removable from the cavity when the arm of the liner is moved laterally away from the second elongate side into an unlocked position.

12. The utility knife of claim 9, further comprising a screwdriver detachably coupled to the handle, the screwdriver is configured to decouple the first blade and the blade holder.

13. The utility knife of claim 9, wherein the blade holder is positioned between the first elongate side of the handle and the liner and the second blade is positioned between the liner and the second elongate side of the handle.

14. The utility knife of claim 9, wherein the curved end surface is concave relative to the slot.

15. A utility knife comprising:
a handle comprising:
an interior surface that defines a cavity; and
a slot connected to the cavity;
a liner coupled to the handle, the liner disposed within the cavity, the liner comprising:
a body; and
a biasing arm that extends laterally from the body, the biasing arm comprising:
a projection extending from a distal end of the biasing arm, the projection extending downward and away from the slot;
a first blade comprising a cutting edge;
a blade holder coupled to the first blade, the blade holder pivotable with respect to the handle between an extended position and a folded position; and
a second blade positioned within the cavity, the second blade interfaces with the distal end of the biasing arm.

16. The utility knife of claim 15, wherein the projection comprises a curved end surface.

17. The utility knife of claim 15, wherein the distal end of the biasing arm is movable laterally relative to the body between a locked position and an unlocked position.

18. The utility knife of claim 17, wherein, when the biasing arm is in the locked position, the distal end restrains the second blade within the cavity, and wherein, when the biasing arm is in the unlocked position, the second blade is removable from the cavity.

19. The utility knife of claim 15, wherein the second blade comprises a recess, and wherein the biasing arm interfaces with the recess.

20. The utility knife of claim 15, wherein the handle further comprises a first elongate side member and an opposing second elongate side member that collectively define the cavity, wherein the first elongate side member and the second elongate side member are coupled together.
